(19) United States
(12) Patent Application Publication
(10) Pub. No.: US 2006/0138077 A1
(43) Pub. Date: Jun. 29, 2006

(54) Method of making an angled tip for a scanning force microscope

(76) Inventor: Hongtao Cui, Knoxville, TN (US)

Correspondence Address: UT-Battelle, LLC;Office of Intellectual Property, One Bethal Valley Road, 4500N, MS-6258, Oak Ridge, TN, 37831, US

(21) Appl. No.: 11/346,745

(22) Filed: Feb. 3, 2006

Related U.S. Application Data
(62) Division of application No. 10/930,359, filed on Aug. 31, 2004, now abandoned.

(51) Int. Cl. B44C 1/22; C23F 1/00

(52) U.S. Cl. 216/11; 216/41

(57) ABSTRACT

A method of making a microscope probe includes the steps of: providing a cantilever; depositing a masking layer on a surface of the cantilever; developing a deterministic spot of the masking layer; removing the deterministic spot of the masking layer from the cantilever to form a deterministic spot of exposed cantilever; depositing a layer of nanostructure-growth catalyst directly on and in contact with the cantilever at the deterministic spot of exposed cantilever; removing the masking layer from the cantilever so that a dot of the catalyst remains on the cantilever at the deterministic spot; and growing a nanostructure at the deterministic spot.

### CROSS-REFERENCE TO RELATED APPLICATIONS

This application is a divisional application of U.S. patent application Ser. No. 10/930,359 filed on Aug. 31, 2004, entitled “Angled Tip for a Scanning Force Microscope” the entire disclosure of which is incorporated herein by reference.

The United States Government has rights in this invention pursuant to contract no. DE-AC05-000R22725 between the United States Department of Energy and UT-Battelle, LLC.

### FIELD OF THE INVENTION

The present invention relates to methods of making scanning probe microscope tips, and more particularly to methods of making scanning probe microscope tips that comprise nanostructures attached to cantilevers at a distally oriented angle.

### BACKGROUND OF THE INVENTION

The probe tip is an essential part of a scanning force microscope. High-aspect ratio and sharp tips are required for high resolution surface imaging; magnetic tips are required for magnetic structure imaging. Standard commercial scanning probe tips are generally made of silicon or silicon nitride with a large, wide tip cone angle. Although high-aspect ratio and sharp probe tips with intermediate full tip cone angle are commercially available, they are usually very expensive and not robust enough to survive “tip-crash” with the surface during microscope operation. Nanostructures such as cylindrical carbon nanotubes (CNTs), for example, have also been used as probe tips due to their high-aspect ratio and nanometer-sized diameter. They can be mounted on commercial probe tips with glues by scanning over a mat of CNTs, which is a tedious process and the success rate is low. They can also be grown on probe tips with catalyst in a Chemical Vapor Deposition (CVD) process. However, both processes experience difficulties in controlling the numbers of CNTs on the tips, their length, and orientations.

When used in magnetic force microscopy, probe tips are made of either magnetic wires or commercial scanning probe tips coated with magnetic thin film materials. They usually lack sharp tips for high-resolution surface imaging, or the well-defined (preferably single) domain structure for magnetic surface imaging. Optimization of tips is needed in order to acquire quantitative data.

The entire disclosure of U.S. Pat. No. 6,649,431, issued Nov. 18, 2003 entitled “Method for Mass Production of Carbon Tips with Cylinder-on-Cone Shape” to Vladimir I. Merkulov, Douglas H. Lowndes, Michael A. Guillorn, and Michael L. Simpson is hereby expressly incorporated herein by reference for all purposes.

The entire disclosure of U.S. Patent Application U.S. Ser. No. 10/068,795, filed Feb. 6, 2003, publication number 20030148577A1, publication date Aug. 7, 2003 (PCT/US03/03387, filed Feb. 5, 2003) entitled “Controlled Alignment of Catalytically Grown Nanostructures in a Large-Scale Synthesis Process” by Vladimir I. Merkulov, Anatoli V. Melechko, Michael A. Guillorn, Douglas H. Lowndes, and Michael L. Simpson is hereby expressly incorporated herein by reference for all purposes.

The entire contents of U.S. Patent Application U.S. Ser. No. 10/408,294, filed Apr. 7, 2003 entitled “Parallel Macromolecular Delivery and Biochemical/Electromchemical Interface to Whole Cells Employing Carbon Nanofibers” by Timothy E. McKnight, Anatoli V. Melechko, Guy D. Griffin, Michael A. Guillorn, Vladimir L. Merkulov and Michael L. Simpson is hereby expressly incorporated herein by reference for all purposes.

The entire disclosure of U.S. patent application Ser. No. 10/716,770 filed on Nov. 19, 2003 entitled “Vertically Aligned Nanostructure Scanning Probe Microscope Tips” by Michael A. Guillorn, Bojan Ilic, Anatoli V. Melechko, Vladimir I. Merkulov, Douglas H. Lowndes, and Michael L. Simpson is incorporated herein by reference for all purposes.

### OBJECTS OF THE INVENTION

Accordingly, objects of the present invention include provision of a simple, inexpensive method of making a scanning probe microscope tip mounted on a cantilever, particularly at a distally oriented angle, and a scanning probe microscope tip mounted on a cantilever at a distally oriented angle in order to improve contact angle with a microscopy sample. Further and other objects of the present invention will become apparent from the description contained herein.

### SUMMARY OF THE INVENTION

In accordance with an aspect of the present invention, a method of making the microscope probe can include the steps of: providing a cantilever; depositing a masking layer on a surface of the cantilever; developing a deterministic spot of the masking layer; removing the deterministic spot of the masking layer from the cantilever to form a deterministic spot of exposed cantilever; depositing a layer of nanostructure-growth catalyst directly on and in contact with the cantilever at the deterministic spot of exposed cantilever; removing the masking layer from the cantilever so that a dot of the catalyst remains on the cantilever at the deterministic spot; and growing a nanostructure at the deterministic spot.

### BRIEF DESCRIPTION OF THE DRAWINGS

In the figures, elements that are essentially the same are called out with the same numerals.

FIG. 1a is a schematic, not-to-scale illustration of various steps in a process of making a scanning probe microscope tip mounted on a cantilever in accordance with the present invention.

FIG. 1b is a cross-sectional view through A-A′ of FIG. 1a.

FIG. 2a is a schematic, not-to-scale illustration of various steps in a process of making a scanning probe microscope tip mounted on a cantilever in accordance with the present invention.

FIG. 2b is a cross-sectional view through B-B′ of FIG. 2a.

FIG. 3a is a schematic, not-to-scale illustration of various steps in a process of making a scanning probe microscope tip mounted on a cantilever in accordance with the present invention.

FIG. 3b is a cross-sectional view through C-C′ of FIG. 3a.

FIG. 4a is a schematic, not-to-scale illustration of various steps in a process of making a scanning probe microscope tip mounted on a cantilever in accordance with the present invention.

FIG. 4b is a cross-sectional view through D-D′ of FIG. 4a.

FIG. 5a is a schematic, not-to-scale illustration of various steps in a process of making a scanning probe microscope tip mounted on a cantilever in accordance with the present invention.

FIG. 5b is a cross-sectional view through E-E′ of FIG. 5a.

FIG. 6a is a schematic, not-to-scale illustration of various steps in a process of making a scanning probe microscope tip mounted on a cantilever in accordance with the present invention.

FIG. 6b is a cross-sectional view through F-F′ of FIG. 6a.

FIG. 7a is a schematic, not-to-scale illustration of various steps in a process of making a scanning probe microscope tip mounted on a cantilever in accordance with the present invention.

FIG. 7b is a cross-sectional view through G-G′ of FIG. 7a.

FIG. 8a is a schematic, not-to-scale illustration of a conventional scanning probe microscope tip in contact with a specimen.

FIG. 8b is a cross-sectional view through H-H′ of FIG. 8a.

FIG. 9a is a schematic, not-to-scale illustration of a scanning probe microscope tip made in accordance with the present invention in contact with a specimen.

FIG. 9b is a cross-sectional view through J-J′ of FIG. 9a.

FIG. 10a is a schematic, not-to-scale illustration of various steps in a process of making a scanning probe microscope tip mounted on a cantilever in accordance with the present invention.

FIG. 10b is a cross-sectional view through K-K′ of FIG. 10a.

FIG. 11a is a schematic, not-to-scale illustration of various steps in a process of making a scanning probe microscope tip mounted on a cantilever in accordance with the present invention.

FIG. 11b is a cross-sectional view through L-L′ of FIG. 11a.

FIG. 12a is a schematic, not-to-scale illustration of various steps in a process of making a scanning probe microscope tip mounted on a cantilever in accordance with the present invention.

FIG. 12b is a cross-sectional view through M-M′ of FIG. 12a.

FIG. 13a is a schematic, not-to-scale illustration of various steps in a process of making a scanning probe microscope tip mounted on a cantilever in accordance with the present invention.

FIG. 13b is a cross-sectional view through N-N′ of FIG. 13a

FIG. 14 is a scanning electron microscope (SEM) image showing a cantilever having a carbon nanostructure attached thereto at a distally oriented angle in accordance with the present invention.

FIG. 15 is a SEM image showing the same cantilever and carbon nanostructure as FIG. 14, but at higher magnification.

FIG. 16 is a SEM image showing a tip portion of the same carbon nanostructure as FIG. 15, but at higher magnification.

For a better understanding of the present invention, together with other and further objects, advantages and capabilities thereof, reference is made to the following disclosure and appended claims in connection with the above-described drawings.

### DETAILED DESCRIPTION OF THE INVENTION

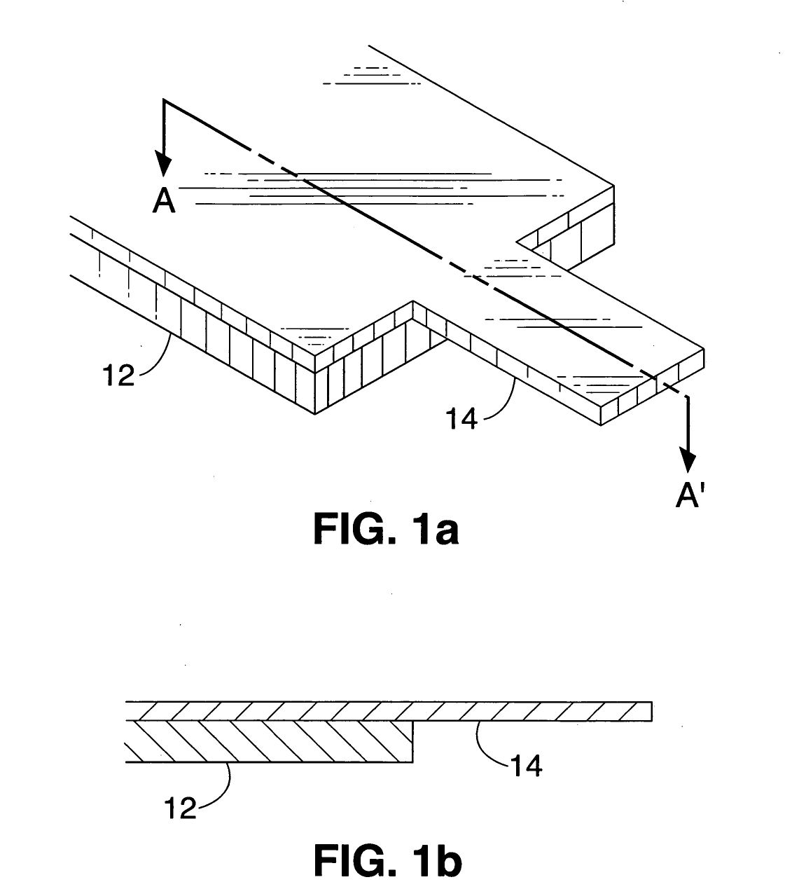

Cantilevers, particularly microcantilevers, can be prepared by known methods and are commercially available. FIGS. 1a, 1b show (schematically, not to scale) a typical cantilever 14 extending from a base 12. Such a cantilever is the starting point in carrying out the present invention. A nanostructure (probe tip) can be grown on the cantilever 14 in a unique series of otherwise conventional method steps described hereinbelow, with an unexpected result of the scanning probe microscope tip being attached to the cantilever at a distally oriented angle. A nanostructure can be comprised of a carbon nanotube (single-walled, double-walled, or multi-walled), a carbon nanofiber, a crystalline nanofiber, or any other adherent, robust structure of appropriate aspect ratio.

It is critical to the present invention that the nanostructure be grown at a deterministic spot on the already-formed cantilever to induce growth at a distally oriented angle. “Deterministic” can be defined to mean that the location, angle, shape and/or composition of the nanostructure can be accurately and precisely controlled and/or reproduced. In order to control the deterministic spot, a dot of nanostructure-growth catalyst must be deposited at the selected spot. The methods of the present invention provide some ways to accomplish the selective deposition of a catalyst dot at the deterministic spot.

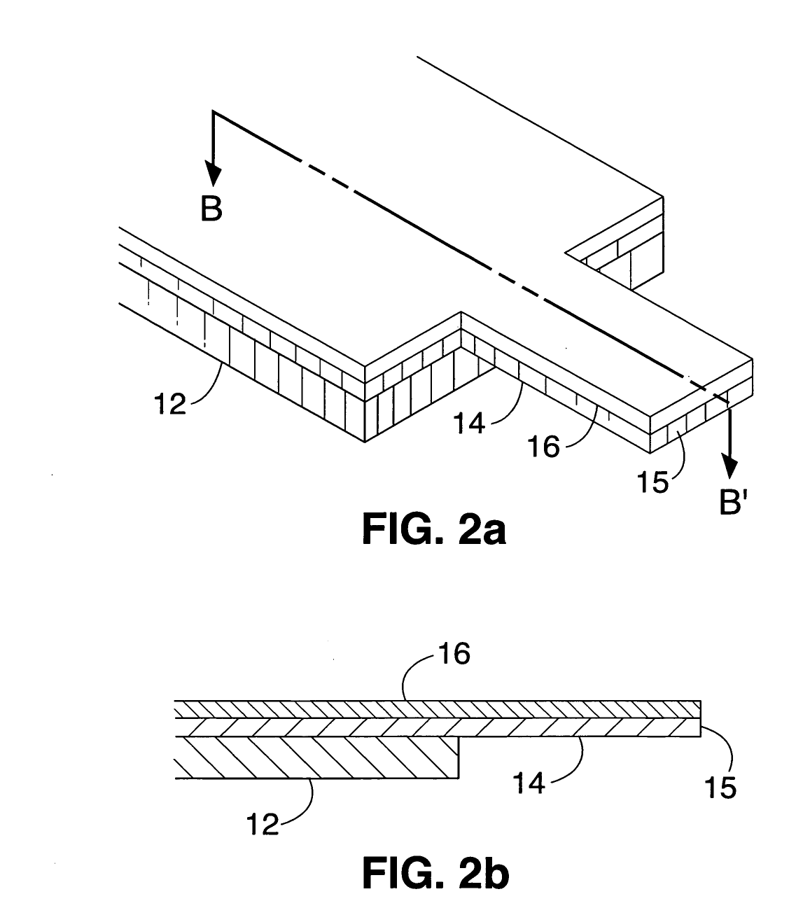

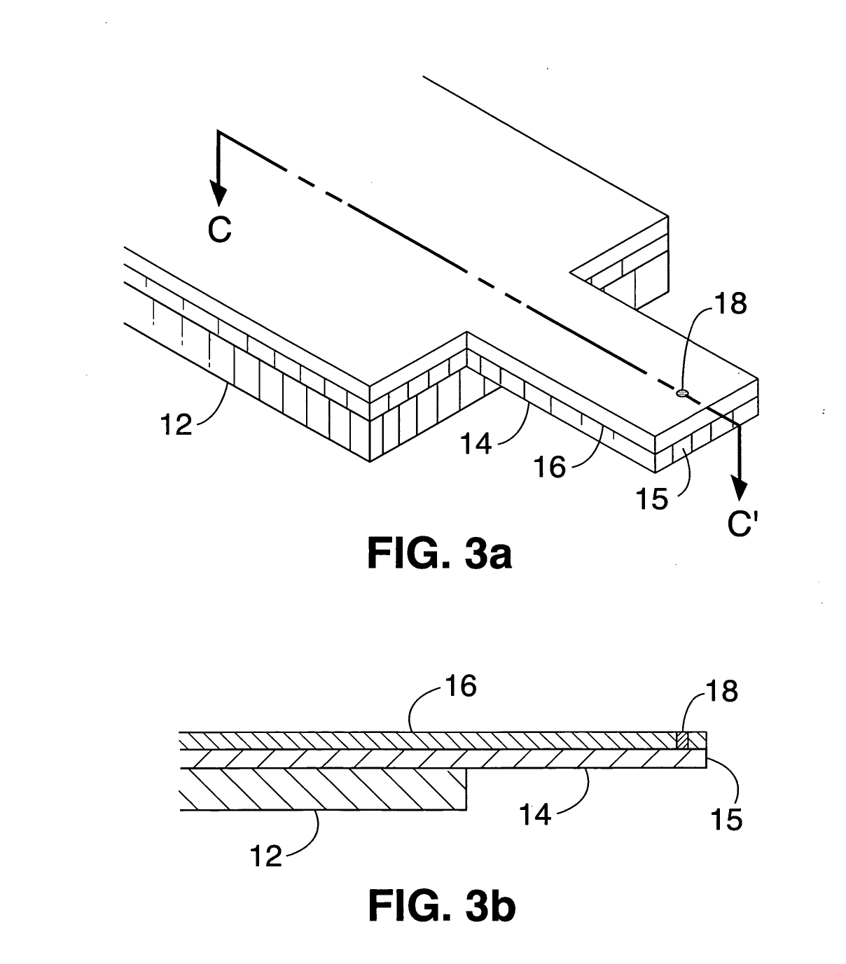

Referring to FIGS. 2a, 2b, the cantilever 12 is coated with a masking layer (e-beam resist or photo resist, for example) 16 by a conventional method. Referring to FIG. 3a, 3b, the masking layer 16 is exposed to directed energy (e-beam, laser, x-ray, or electromagnetic, for example) by a conventional method near the free (distal) edge 15 of the cantilever 14 to form a spot 18 of exposed masking layer 16 at an appropriate location for subsequent, deterministic growth of a nanostructure (probe tip).

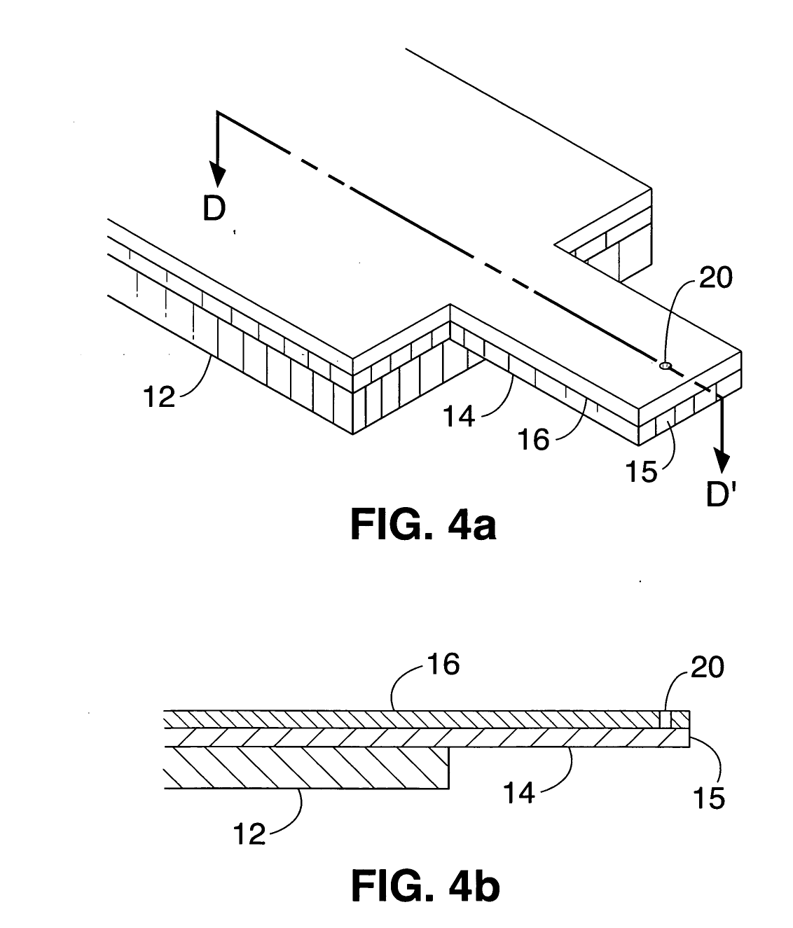

Referring to FIGS. 4a, 4b, the exposed spot 18 is developed and removed by a conventional method, leaving a perforation 20 in the masking layer 16, exposing the cantilever 14.

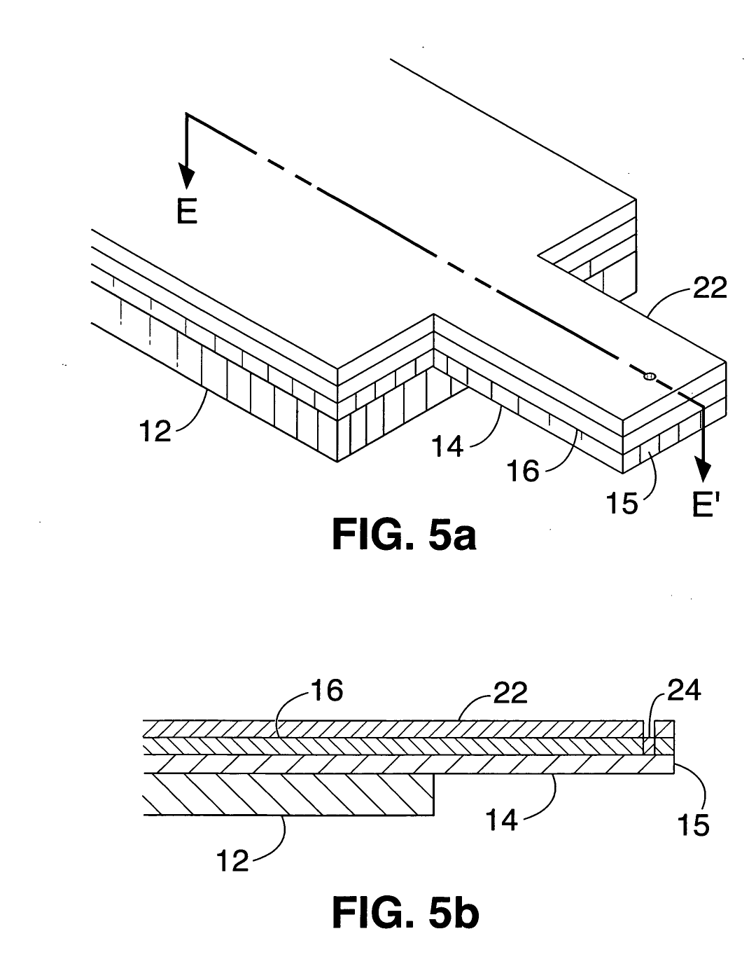

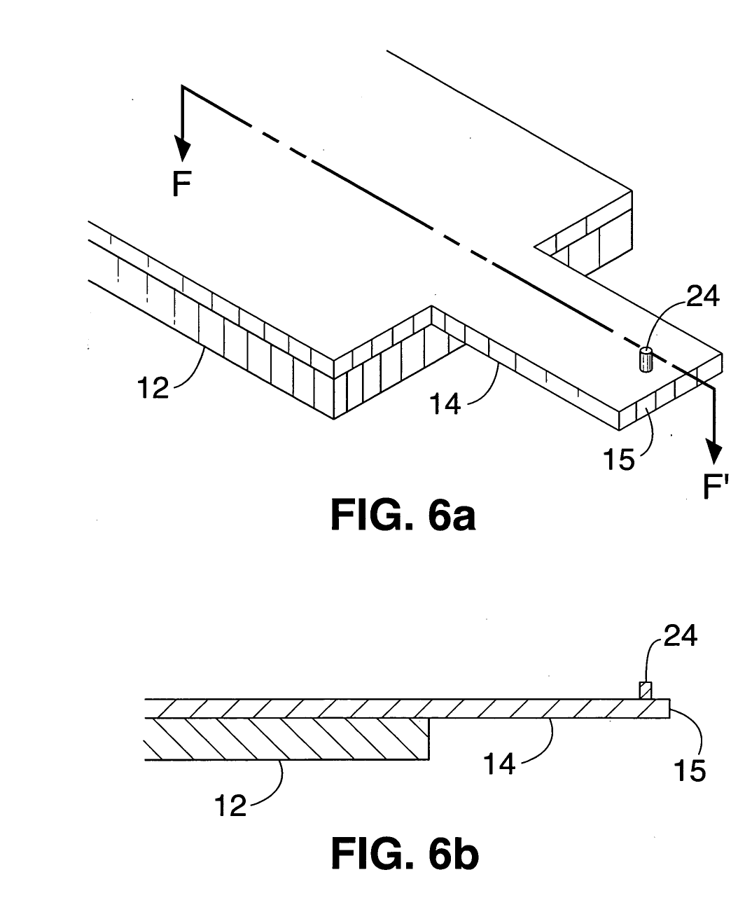

Referring to FIGS. 5a, 5b, the cantilever 14 and masking layer 16 are further coated with a layer of nanostructure-growth catalyst 22, such as Ni, Fe, Co, Cu, and Pd for example, by a conventional deposition method. A catalyst dot 24 is thereby deposited through the perforation 20 (FIGS. 4a, 4b) directly onto the cantilever 14. Referring to FIGS. 6a, 6b, the masking layer 16 and catalyst 22 are then removed from the cantilever 14 by a conventional method, leaving the catalyst dot 24 on the cantilever 14.

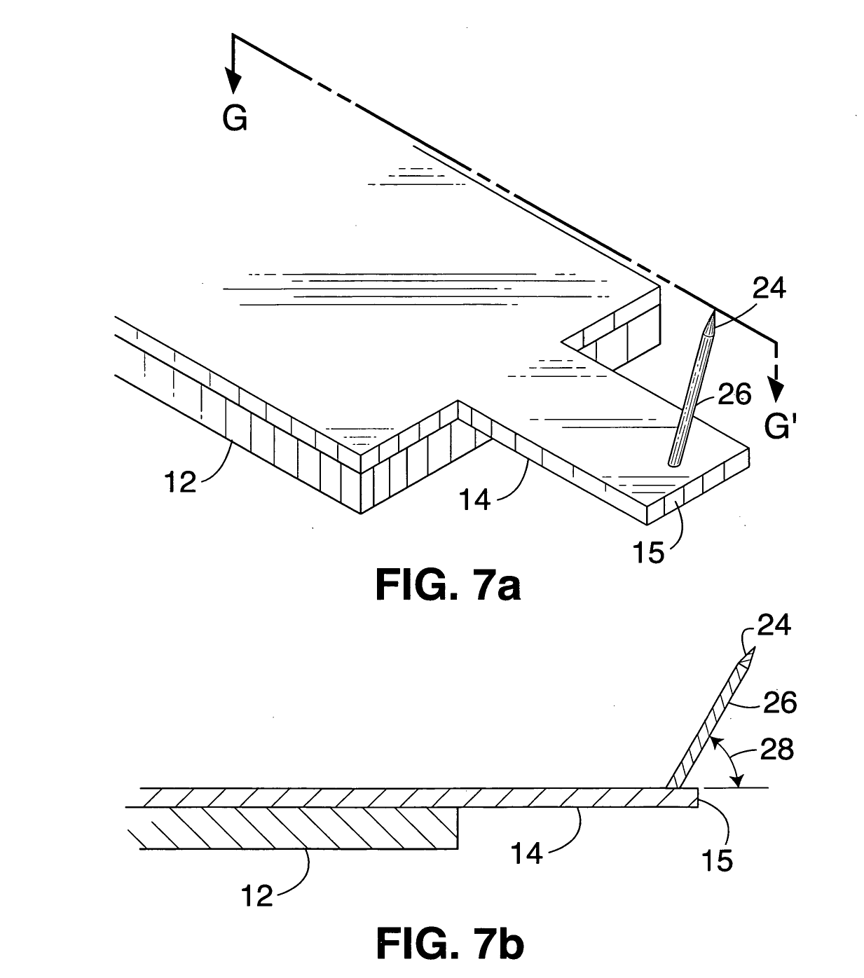

Referring to FIGS. 7a, 7b, a carbon nanostructure 26 is grown on the cantilever 14 by direct current plasma enhanced chemical vapor deposition (DC-PECVD), a conventional method. The nanostructure 26 may “push” at least a portion of the catalyst dot 24 to the tip of the nanostructure 26 as the nanostructure 26 grows. Due to perturbation of the energy field of the plasma by the cantilever 14, the nanostructure 26 grows at a distally oriented angle 28.

During growth, the nanostructure 26 does not grow perpendicularly to the cantilever 14 surface as would generally be expected. Because the method of the present invention causes the growth of a single nanostructure 26 on a previously formed cantilever 14, the distal end 15 of the cantilever 14 causes a perturbation of the energy field of the plasma so that, as the nanostructure 26 grows, it is attracted toward the distal end 15 of the cantilever 14, causing the nanostructure 26 to “lean” in the direction of the attraction. The result is a nanostructure 26 attached to the cantilever 14 at a distally oriented angle 28, useful as a scanning probe microscope tip. The distally oriented angle 28 can be any angle in the range of less than 90° to about 45°, preferably in the range of about 85° to about 60°, more preferably in the range of about 80° to about 70°, most preferably in the range of about 75°.

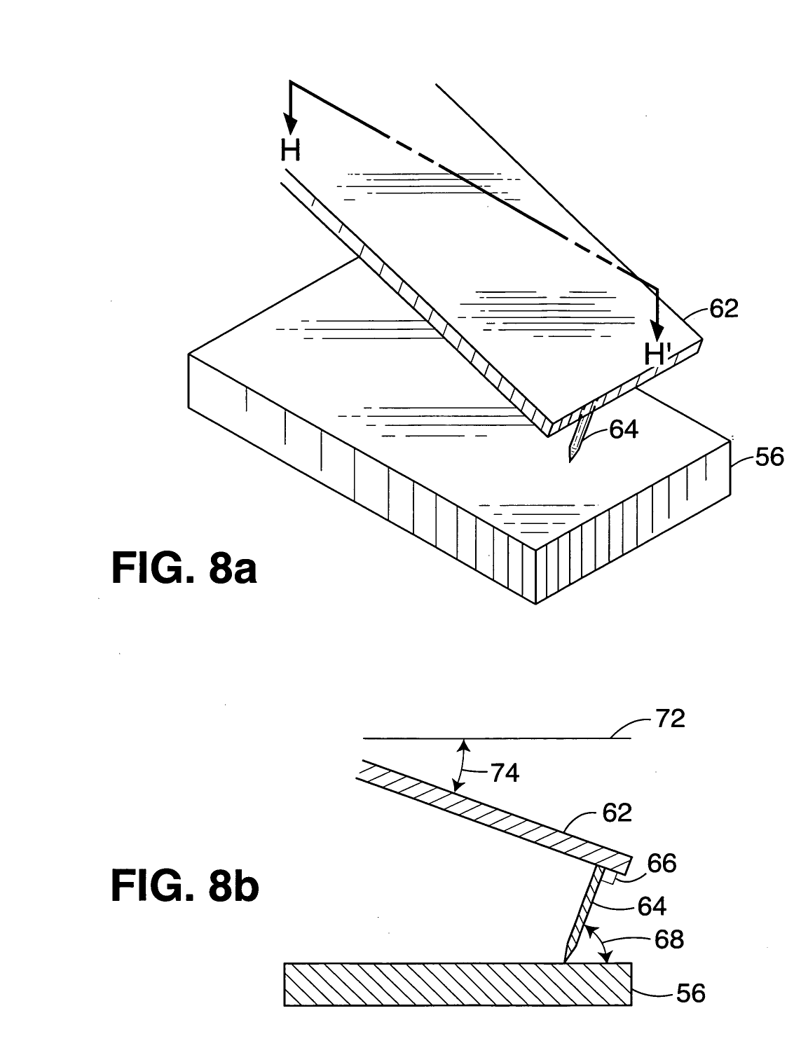

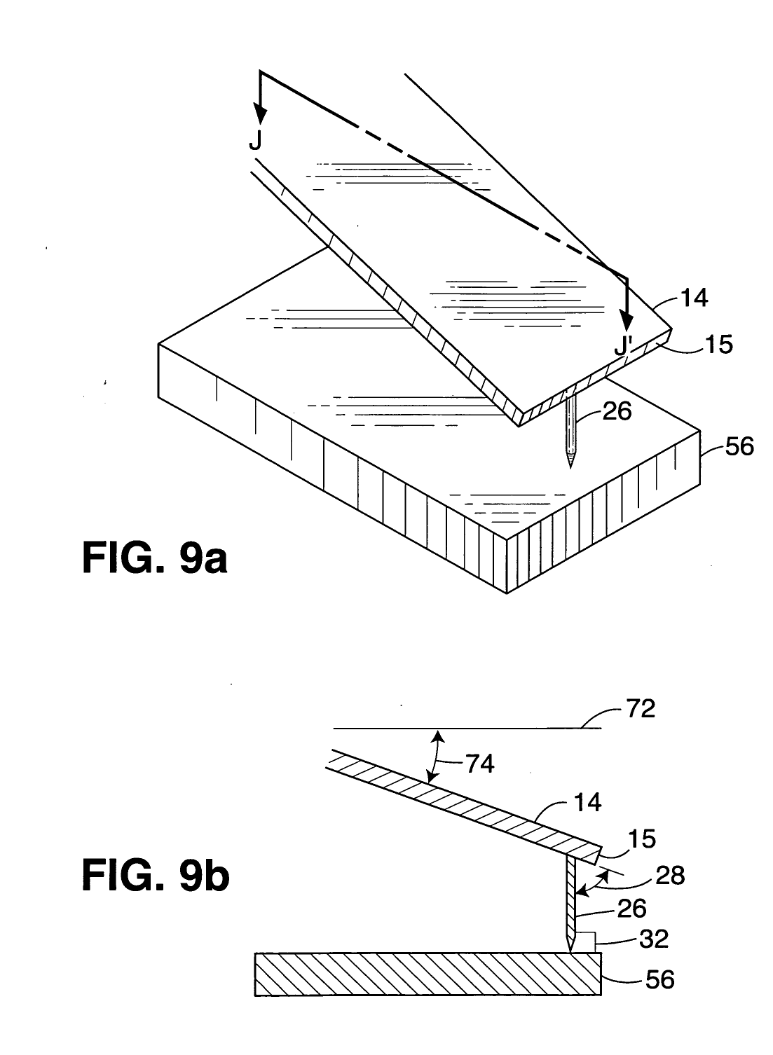

FIGS. 8a, 8b, and 9 illustrate an advantage of the distally oriented angle 28 of the nanostructure. FIGS. 8a, 8b show a conventional scanning probe microscope tip 64 attached to a cantilever 62 at a right angle 66 (vertically aligned). In a typical scanning probe microscope, the cantilever 62 is held at an angle of inclination 74 from horizontal 72 which results in contact of the tip 64 with the specimen 56 at a non-perpendicular contact angle 68.

Referring now to FIGS. 9a, 9b, a scanning probe microscope tip 26 attached to a cantilever 14 at a distally oriented angle 28 in accordance with the present invention. In the same scanning probe microscope as described above, the cantilever 14 is held at an angle of inclination 74 from horizontal 72. The distally oriented angle 28 of the tip 26 tends to offset and/or compensate for the angle of inclination 74, resulting in improved contact of the tip 26 with the specimen 56 at an ideally perpendicular contact angle 32. The contact angle 32 can be less than 90°, but in any case, it will be greater than the contact angle 68 of a conventional scanning probe microscope tip 64 shown in FIGS. 8a, 8b.

Spurious fragments of catalyst may become attached along the edges of the cantilevers. Additional steps can be carried out in order to reduce the possibility of growing spurious nanostructures on the edges of the cantilevers. The following steps are preferably carried out after the catalyst dot has been made, but before a nanostructure is grown on the catalyst dot.

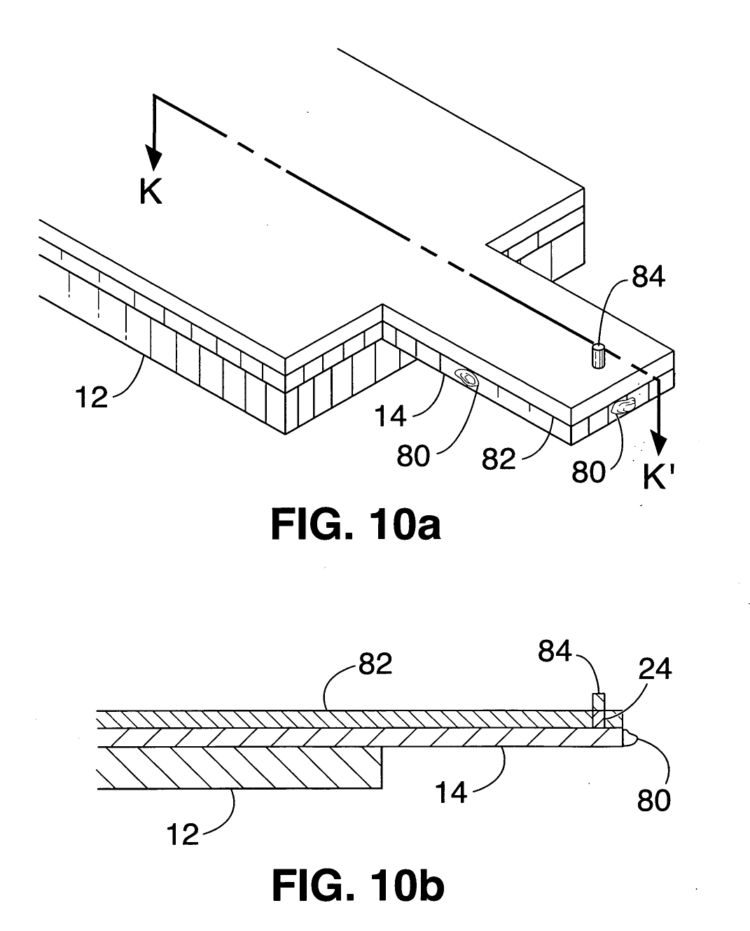

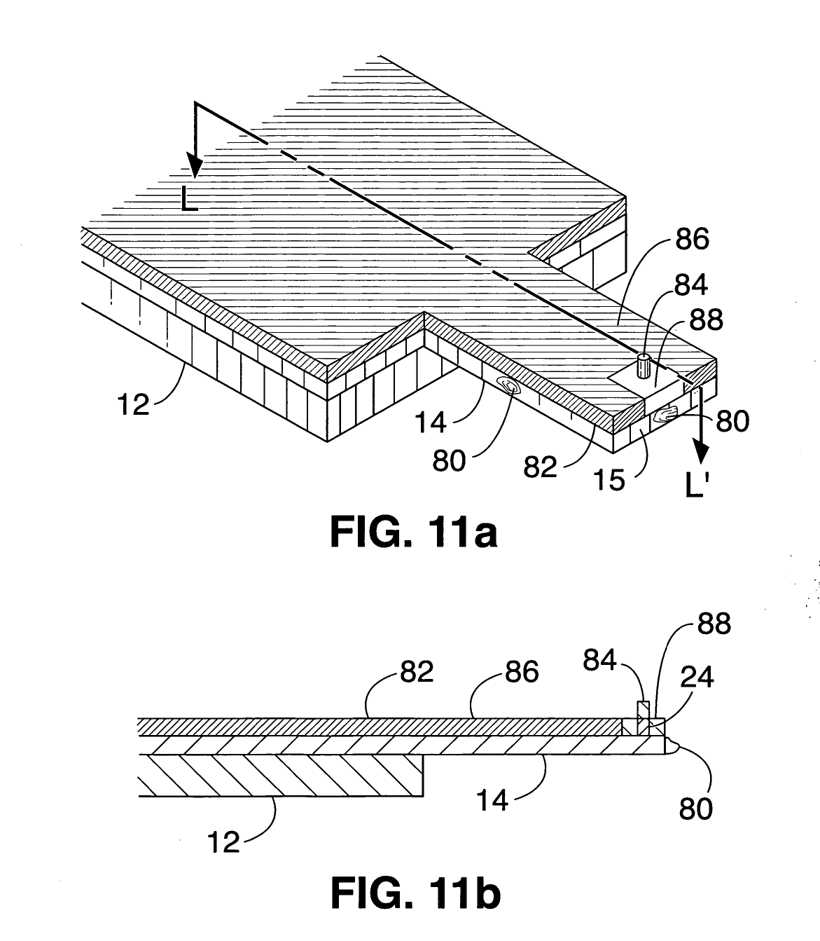

Referring to FIGS. 10a, 10b, the cantilever 14 having catalyst dot 24 and spurious catalyst fragments 80 is coated with masking layer 82 by a conventional method. The masking layer 82 covers the catalyst dot 24, likely resulting in a protuberance 84 of masking layer 82 thereover. Referring to FIGS. 11a, 11b, the masking layer 82 is exposed over the entire cantilever 14 except a small area around the catalyst dot 24 to form a patch 88 of unexposed masking layer 82, including the protuberance 84 thereof, over the catalyst dot 24.

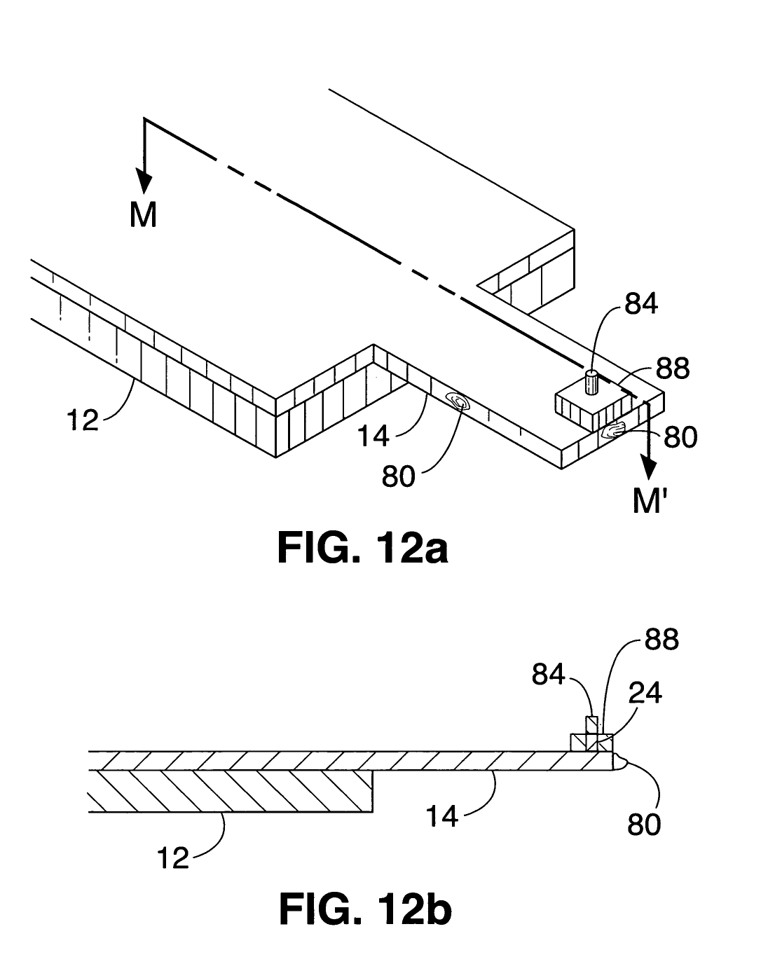

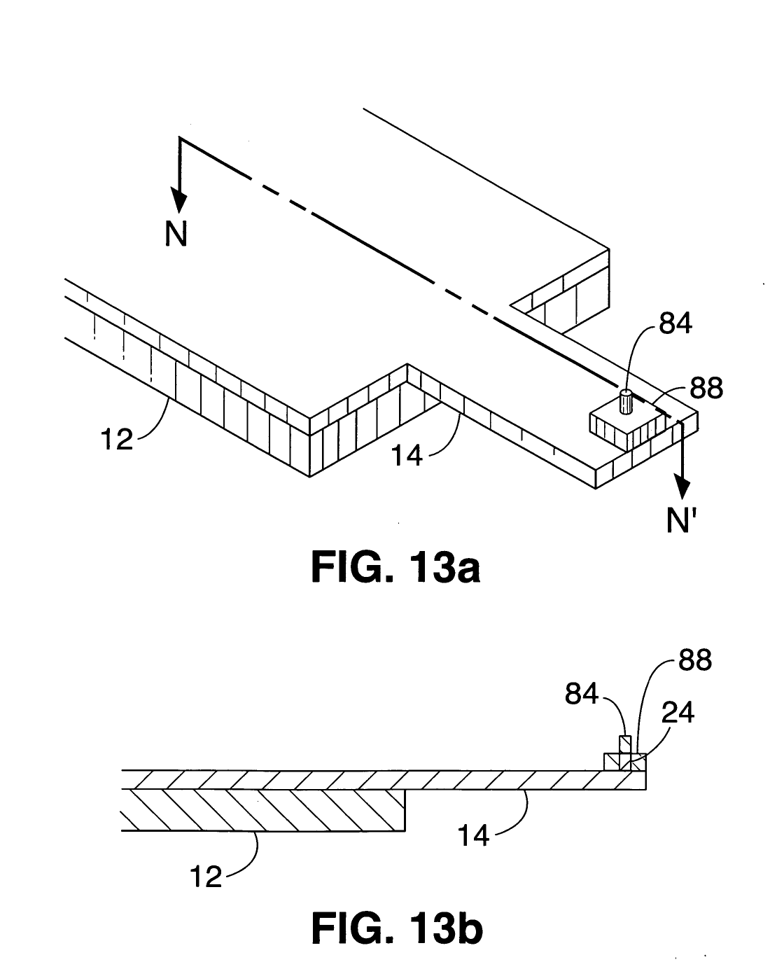

Referring to FIGS. 12a, 12b, the exposed masking layer 86 is developed and removed by a conventional method, leaving the patch 88. Referring to FIGS. 13a, 13b, the spurious catalyst fragments 80 are removed by, for example, an etchant, the patch 88 protecting the catalyst dot 24 from the etchant. The patch 88 is then lifted off the cantilever 14 and catalyst dot 24 by a conventional method and removed, leaving the catalyst dot 24 on the cantilever 14, as shown in FIGS. 6a, 6b.

### EXAMPLE I

Tipless (blank) cantilevers (NSC12/Tipless no A1, MikroMasch USA, Portland, Oreg.) were first immersed in an acid mixture of 1 part HNO₃ and 1 part H₂SO₄ for at least 10 minutes to generate hydrophilic surfaces. The cantilevers were immersed in deionized water to remove acids. The cantilevers were subsequently ultra-sonicated in acetone for 1 minute, immersed in methanol for 20 seconds and blown dry using compressed nitrogen gas to generate a clean surface.

A layer of polymethyl methacrylate (PMMA) (495K, 8% in anisole) was coated on the cantilevers using a spin-coating process operated at 8000 RPM for 40 seconds, followed by baking on a hot plate at 180° C. for 2 minutes.

The cantilevers were subsequently loaded in a scanning electron microscope (SEM) (Hitachi model S4700) with electron beam lithography capabilities (operated using NPGS software from J. C. Nabity Lithography Systems, Bozeman, Mont.). A dot (pattern) having a diameter of a size in the range of from 100 nm to 400 nm was written near the distal edge of each of the cantilevers using the electron beam lithography.

The e-beam written dots were developed by immersing them in a solution of 1 part of methyl isobutyl ketone (MIBK) and 3 parts of isopropyl alcohol (IPA) for 90 seconds, transferring to IPA for 20 seconds, and transferring to de-ionized water for 20 seconds. The surfaces of the cantilevers were blown dry using compressed nitrogen gas.

A nickel or iron catalyst coating having a thickness in the range of 10-50 nm was evaporated onto each of the cantilevers by electron beam evaporation. Pattern lift-off was performed by immersing the cantilevers in acetone for 1 hour, followed by ultra-sonication in acetone for 1 minute, immersion in methanol for about 20 seconds, and blowing dry using compressed nitrogen gas. A dot of catalyst was left at the site of the e-beam written dot.

In order to remove spurious fragments of catalyst, the cantilevers were spin-coated again with PMMA (495K, 8% in anisole) at 8000 RPM for 40 seconds, followed by baking on a hot plate at 180° C. for 2 minutes. Electron beam lithography was performed to expose areas on the cantilevers except the catalyst dot and a small surrounding area. The exposed area was lifted off in MIBK:IPA (1:3) for 40 seconds, immersed in IPA for 20 seconds, de-ionized water for 20 seconds, and blown dry using compressed nitrogen gas.

The cantilevers were immersed in an etchant for 20 min. Type TFB etchant was used for nickel etching at room temperature and Type I etchant was used for iron etching at 40° C. (The etchants are available from Transene Company, Inc. Danvers, Mass.) Following iron etching, the cantilevers were immersed in a solution of 10% HCl in water at 40° C. for 20 min. Spurious nickel or iron attached on the edges of the cantilevers was thus removed. The cantilevers were immersed in deionized water to remove the etchants. The cantilevers were then immersed in acetone for 1 hour and in methanol for 20 seconds to remove the PMMA remaining on the catalyst dot pattern. The cantilevers were blown dry using compressed nitrogen gas.

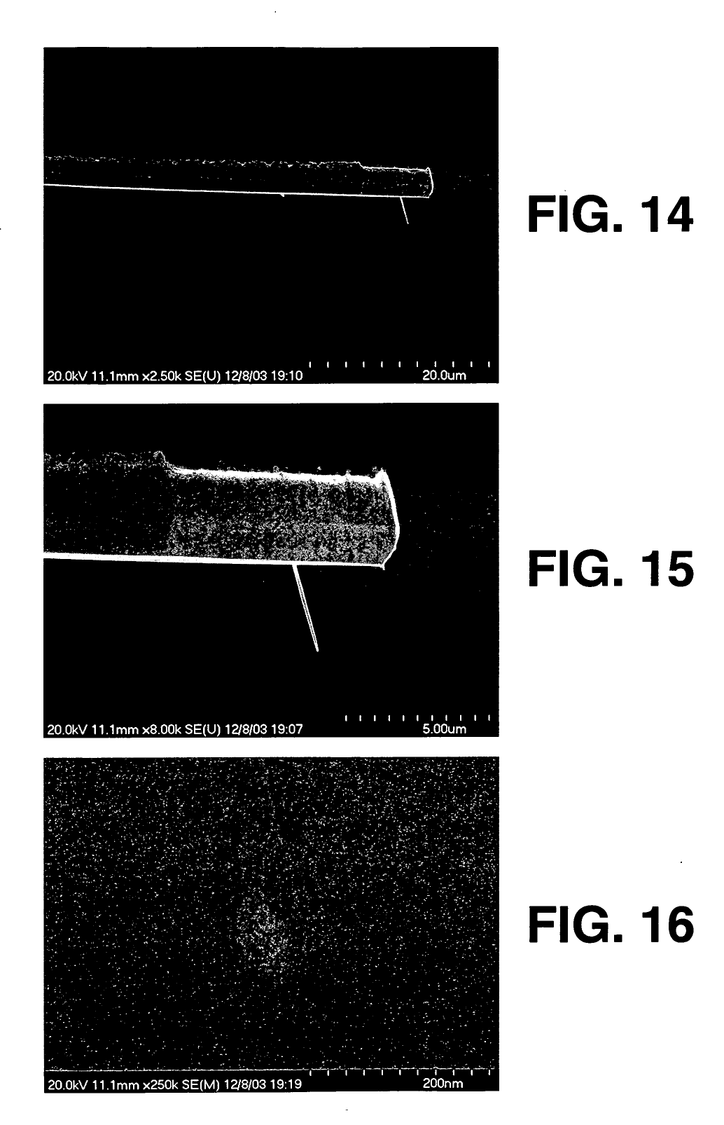

The cantilevers with a nickel dot were transferred into a Direct Current Plasma Enhanced Chemical Vapor Deposition (DC-PECVD) reactor. A carbon nanofiber (CNF) was grown on each cantilever. FIG. 14 shows a cantilever with a CNF attached thereto at a distally oriented angle. FIG. 15 shows the same cantilever and CNF at higher magnification. FIG. 16 shows the tip of the same CNF, revealing a particle of Ni catalyst (lighter shade).

Photo-resist can be substituted for e-beam resist in any of the method steps described hereinabove. Any suitable masking method can be used.

While there has been shown and described what are at present considered the preferred embodiments of the invention, it will be obvious to those skilled in the art that various changes and modifications can be prepared therein without departing from the scope of the inventions defined by the appended claims.

What is claimed is:

1. A method of making a microscope probe comprising the steps of:
a. providing a cantilever;
b. depositing a masking layer on a surface of said cantilever;
c. developing a deterministic spot of said masking layer;
d. removing said deterministic spot of said masking layer from said cantilever to form a deterministic spot of exposed cantilever;
e. depositing a layer of nanostructure-growth catalyst directly on and in contact with said cantilever at said deterministic spot of exposed cantilever;
f. removing said masking layer from said cantilever so that a dot of said catalyst remains on said cantilever at said deterministic spot; and
g. growing a nanostructure at said deterministic spot.

2. A method of making a microscope probe in accordance with claim 1 wherein said masking layer comprises at least one of the group consisting of e-beam resist and photo resist.

3. A method of making a microscope probe in accordance with claim 1 wherein said nanostructure comprises a carbon nanotube.

4. A method of making a microscope probe in accordance with claim 3 wherein said nanotube comprises a single-wall nanotube.

5. A method of making a microscope probe in accordance with claim 3 wherein said nanotube comprises a double-wall nanotube.

6. A method of making a microscope probe in accordance with claim 3 wherein said nanotube comprises a multi-wall nanotube.

7. A method of making a microscope probe in accordance with claim 1 wherein said nanostructure comprises a nanofiber.

8. A method of making a microscope probe in accordance with claim 7 wherein said nanofiber comprises a carbon nanofiber.

9. A method of making a microscope probe in accordance with claim 7 wherein said nanofiber comprises a crystalline nanofiber.

10. A method of making a microscope probe in accordance with claim 1 wherein said nanostructure is grown at a distally oriented angle.

11. A method of making a microscope probe in accordance with claim 1 further comprising, after said step of removing said masking layer and before said step of growing a nanostructure, the following additional steps to remove a spurious catalyst fragment from said cantilever:
a. providing a patch of masking material that covers said catalyst dot;
b. etching said spurious catalyst fragment from said cantilever, said patch of masking material protecting said catalyst dot; and
e. removing said patch of masking material.
